(19) United States
(12) Patent Application Publication
(10) Pub. No.: US 2018/0025456 A1
(43) Pub. Date: Jan. 25, 2018

(54) METHOD, DEVICE, AND SYSTEM FOR MANAGING AND USING LEARNING OUTCOMES

(71) Applicants: Sebastian Mihai, Kitchener (CA); Brian Pearson, Kitchener (CA); Phillip Brown, Kitchener (CA); Phil McClelland, Kitchener (CA); Mike Dedy, Kitchener (CA); Baljeet Bilkhu, Kitchener (CA); Andy Slough, Kitchener (CA)

(72) Inventors: Sebastian Mihai, Kitchener (CA); Brian Pearson, Kitchener (CA); Phillip Brown, Kitchener (CA); Phil McClelland, Kitchener (CA); Mike Dedy, Kitchener (CA); Baljeet Bilkhu, Kitchener (CA); Andy Slough, Kitchener (CA)

(21) Appl. No.: 15/654,257

(22) Filed: Jul. 19, 2017

Related U.S. Application Data
(60) Provisional application No. 62/364,089, filed on Jul. 19, 2016.

(51) Int. Cl. G06Q 50/20

(52) U.S. Cl. CPC G06Q 50/205

(57) ABSTRACT

There are provided methods, devices, and systems for managing and using learning outcomes. The method comprises identifying a high-level learning outcome, and identifying a first and second low-level learning outcomes associated with the high-level learning outcome. A first grade associated with the first low-level learning outcome is obtained, and a second grade associated with the second low-level learning outcome is obtained. An outcome grade is calculated based on the first grade and the second grade, which pertains to the high-level outcome.

### RELATED APPLICATIONS

This application claims the benefit of U.S. Provisional Patent Application No. 62/364,089, filed Jul. 19, 2016, the entire contents of which are hereby incorporated by reference herein.

### TECHNICAL FIELD

The embodiments herein relate to information systems, and in particular to systems and methods that provide educational information.

### INTRODUCTION

Electronic learning (also called e-Learning or eLearning) generally refers to education or learning where users engage in education related activities using computers and other computer devices. For example, users may enroll or participate in a course or program of study offered by an educational institution or other organizations (e.g. a college, university, grade school, a business or a governmental organization) through a web interface that is accessible over the Internet. Similarly, users may receive assignments electronically, participate in group work and projects by collaborating online, and be graded based on assignments and examinations that are submitted using an electronic drop box.

An electronic learning system may be used to facilitate electronic learning. The electronic learning system contains a plurality of software and hardware components necessary to implement various features of electronic learning. For example, such features may include: use of electronic learning materials (e.g. handouts, textbooks, etc.), web-casting of live or recorded lectures, interaction through virtual chat-rooms or discussion boards, and performing web-based presentations. The users may access such features through a centralized electronic learning environment.

### BRIEF DESCRIPTION OF THE DRAWINGS

The drawings included herewith are for illustrating various examples of articles, methods, and apparatuses of the present specification. In the drawings:

FIG. 1 is a schematic diagram of an electronic learning system;

FIG. 2 is a flow diagram of a method for managing and using learning outcomes according to some embodiments; and

FIG. 3 is a flow diagram of a method for managing and using learning outcomes according to some embodiments.

### DETAILED DESCRIPTION

Various apparatuses or processes will be described below to provide an example of an embodiment of each claimed invention. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses described below. It is possible that an apparatus or process described below is not an embodiment of any claimed invention. Any invention disclosed below that is not claimed in this document may be the subject matter of another protective instrument, for example, a continuing patent application, and the applicants, inventors or owners do not intend to abandon, disclaim or dedicate to the public any such invention by its disclosure in this document.

Furthermore, this description is not to be considered as limiting the scope of the embodiments described herein in any way, but rather as merely describing the implementation of various embodiments as described.

In some cases, the embodiments of the systems and methods described herein may be implemented in hardware or software, or a combination of both. In some cases, embodiments may be implemented in one or more computer programs executing on one or more programmable computing devices comprising at least one processor, a data storage device (including in some cases volatile and non-volatile memory and/or data storage elements), at least one input device, and at least one output device.

In some embodiments, each program may be implemented in a high level procedural or object oriented programming and/or scripting language to communicate with a computer system. However, the programs can be implemented in assembly or machine language, if desired. In any case, the language may be a compiled or interpreted language.

In some embodiments, the systems and methods as described herein may also be implemented as a non-transitory computer-readable storage medium configured with a computer program, wherein the storage medium so configured causes a computer to operate in a specific and predefined manner to perform at least some of the functions as described herein.

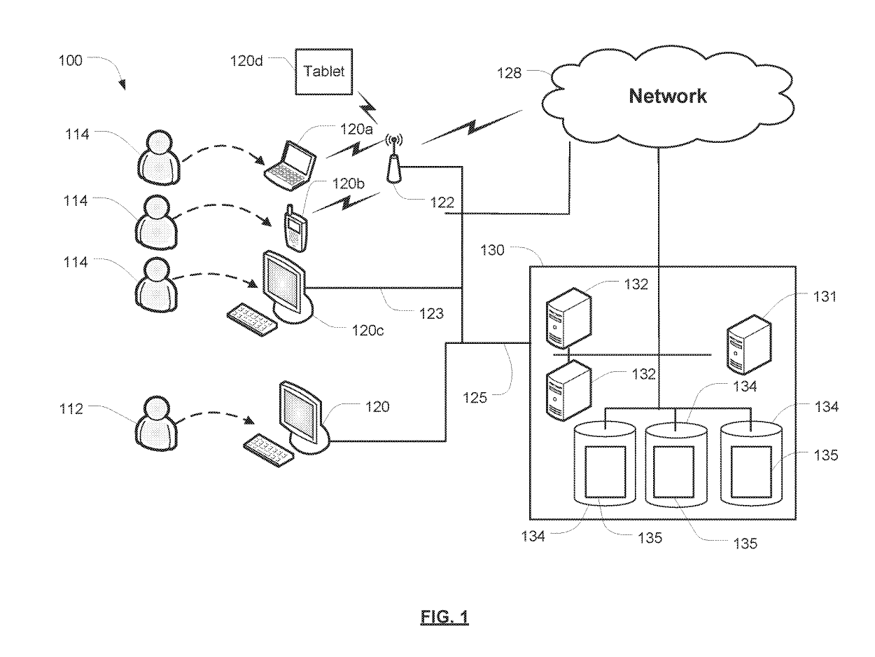

Turning now to FIG. 1, illustrated therein is a system 100 for providing a learning management system, according to one embodiment.

Using the system 100, one or more users 112, 114 may communicate with an educational service provider 130 to participate in, create, and consume electronic learning services. The users 112, 114 may be individuals or user accounts associated with the users.

In some cases, the educational service provider 130 may be part of or 2 associated with a traditional “bricks and mortar” educational institution (e.g. a grade school, university or college), another entity that provides educational services (e.g. a company that specializes in offering training courses, or an organization that has a training department), or may be an independent service provider (e.g. for individual electronic learning).

The users 112, 114 may consume learning services. The users 112, 114 may not necessarily consume like learning services. For example, the user 112 may consume learning services provided to learners of one particular course, while users 114 may consume learning services provided to learners in another course.

The communication between the users 112, 114 and the educational service provider 130 can occur either directly or indirectly using any suitable computing device. For example, the user 112 may use a computing device 120 such as a desktop computer that has at least one input device (e.g. a keyboard and a mouse) and at least one output device (e.g. a display screen and speakers). The computing device 120 can generally be any other suitable device for facilitating communication between the users 112, 114 and the educational service provider 130. For example, the computing device 120 could be a laptop 120a wirelessly coupled to an access point 122 (e.g. a wireless router, a cellular communications tower, etc.), a wirelessly-enabled personal data smart phone 120b or table 120d, or a terminal 120c over a wired connection 123.

The computing devices 120 may be connected to the service provider 130 via any suitable communications channel. For example, the computing devices 120 may be communicate to the educational service provider 130 over a local area network (LAN) or intranet, or using an external network (e.g. by using a browser on the computing device 120 to browse to one or more web pages presented over the Internet 128).

In some examples, one or more of the users 112, 114 may be required to authenticate their identities in order to communicate with the educational service provider 130. For example, the users 112, 114 may be required to input a login name and/or a password to gain access to the services provided by the educational service provider 130.

In some embodiments, the wireless access points 122 may connect to the educational service provider 130 through a data connection 125 established over the LAN or intranet. Alternatively, the wireless access points 122 may be in communication with the educational service provider 130 via the Internet 128 or another external data communications network. For example, one user 114 may use a laptop 120a to browse to a webpage that displays elements of an electronic learning system.

The educational service provider 130 generally includes a number of functional components for facilitating the provision of electronic learning services. For example, the educational service provider 130 generally includes one or more processing devices 132 (e.g. servers), each having one or more processors. The processing devices 132 are configured to send information (e.g. web page content) to be displayed on one or more computing devices 120 in association with the electronic learning system 100. In some embodiments, the processing device 132 may be a computing device 120 (e.g. a laptop or personal computer).

The educational service provider 130 also generally includes one or more data storage devices 134 that are in communication with the processing devices 132 (e.g. servers), and could include a relational database, file system, or any other suitable data storage device. The data storage devices 134 are configured to host data 135 such as course content and enrollment information.

The data storage devices 134 may also be configured to store other information, such as personal information about the users 112, 114 of the system 110, information about which courses the users 112, 114 are enrolled in, roles to which the users 112, 114 are assigned in various contexts, particular interests of the users 112, 114 and so on.

The processing devices 132 and data storage devices 134 may also be configured to provide other electronic learning capabilities (e.g. allowing users to enroll in courses), and/or may be in communication with one or more other service providers that provide such other electronic learning capabilities.

In some embodiments, the system 100 may also have one or more backup servers 131 that may duplicate some or all of the data 135 stored on the data storage devices 134. The backup servers 131 may be desirable to prevent data loss in the event of an accident such as a fire, flooding, hardware failure, or theft.

In some embodiments, the backup servers 131 may be directly connected to the educational service provider 130 but located within the system 110 at a different physical location. For example, the backup servers 131 could be located at a remote storage location at a distance from the service provider 130, and the service provider 130 could connect to the backup server 131 using a secure communications protocol to ensure that the confidentiality of the data 135 is maintained.

Learning Outcomes are brought into a Learning Management System (“LMS”) via a content publisher, accreditation body, professional development council (in a corporation using an LMS for Personal Development (“PD”) purposes), an administrator, a teacher, or the like. The learning outcomes can be predefined such as by the teacher in connection with a design of a course or a curriculum. In some embodiments, the learning outcomes can associated with one or more courses can be determined based at least in part on one or more resources corresponding to the one or more courses. For example, the LMS or another computing system can derive the learning outcomes for the one more courses based on an analysis of the one or more resources corresponding to the one or more courses. In some embodiments, the LMS or other computing system can perform a semantic analysis on the one or more resources corresponding to the one or more resources and identify the learning outcomes based on the semantic analysis. Other processing or analysis can be performed on the one or more resources in connection with determining the learning outcomes associated with the course.

A set of learning outcomes can be associated with a course, an assessment (e.g., an assessment activity associated with a course such as a quiz, a test, an essay, an abstract, etc.), a resource (e.g, an electronic resource accessible via the LMS such as a video, a summary, a chapter, a text book, etc.) or the like.

As an example, at a high level, a department (e.g., the Mathematics department) must achieve learning outcomes o1, o2, o3, o4, a program co-ordinator distributes (e.g., associates) such learning outcomes to courses (e.g., Mathematics courses). Learning outcomes can be hierarchical. For example, an instructor can refine the learning outcomes by creating outcomes (e.g., sub outcomes) o1_1, o1_2, o1_3, o2_1, o2_2, etc., where o1_1, o1_2, o1_3 are children of the higher level o1.

LMS activities can be aligned to learning outcomes to convey what the learning outcomes are intended to teach the student. In some embodiments, LMS activities are designed based at least in part on the learning outcomes. The LMS activities can be associated with the learning outcomes. For example, LMS activities can have metadata indicating the learning outcomes associated with such LMS activities. LMS activities can correspond to learning activities, courses, or the like. As an example, an instructor can select LMS activities based at least in part on the learning outcomes. As another example, the LMS activities can be automatically aligned or associated with the learning outcomes. The LMS can automatically align or associate the LMS activities with the learning outcomes.

Students are assessed against the learning outcomes aligned to the LMS activities such students undertook throughout courses. The LMS can store one or more assessments associated with the student's completion or performance of the LMS activities. The one or more assessments can correspond to or otherwise be associated with the learning outcomes associated with the LMS activities. Students can achieve one or more educational goals associated with the successful achievement of the one or more learning outcomes. For by meeting sets of high-level outcomes by meeting low-level ones, students achieve high-level goals, such as obtaining a degree, obtaining a certification, etc.

A report can be generated based on learning outcomes. For example, a report based on an individual's (e.g., a student's, learner's, etc.) successful completion of the high-level learning outcomes can be generated. As another example, a report based on an institution's providing one or more courses, assessments, activities, etc. based on the high-level learning outcomes, or the students' (e.g., of the institution) completion of the high-level outcomes, can be generated. The LMS can generate the report. Program coordinators are able to generate reports on the high level outcomes, trying to adhere to accreditation (and other) regulations, etc.

As used herein, the term “learning outcome” means a goal, such as something achieved by performing work in a course. For example, learning outcomes can be represented in directed graphs that show which low-level learning outcomes satisfy higher-level learning outcomes.

As used herein, the term “activity” or learning activity means a work item in an LMS (such as quizzes, individual quiz questions, discussions, assignments, readings, etc.).

As used here, the term “alignment” means an association between a learning outcome and an activity. According to some embodiments, alignment may be stored as a value in a database that is associated with the LMS and/or content provider/publisher).

### 1. Calculating Effectiveness of Activities

In some embodiments, an effectiveness of activities (e.g., learning activities deployed on a Learning Management System) in teaching a certain learning outcome is calculated, and courses (e.g., deployed on a Learning Management System) can be built and course units (e.g., automatically) from activities, based on activity effectiveness scores.

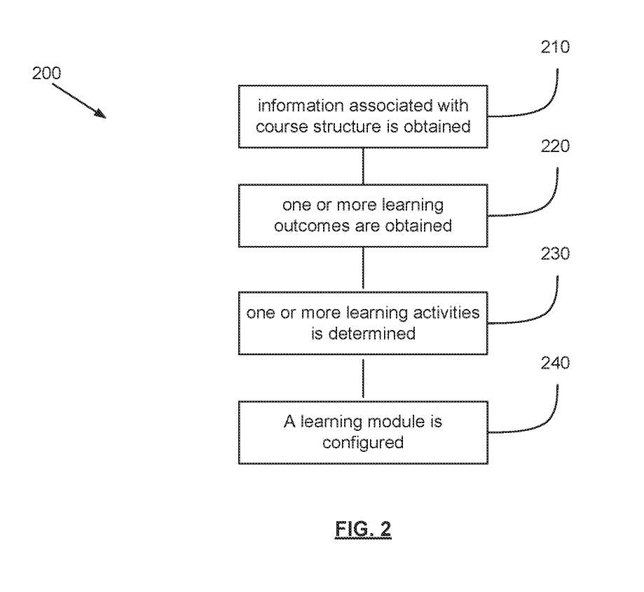

FIG. 2 is a flow diagram of a method for managing and using learning outcomes according to some embodiments.

Referring to FIG. 2, method 200 is provided. Method 200 can be implemented by electronic learning system 100 of FIG. 1, or by a computer system.

At 210, information associated with course structure is obtained. In some embodiments, the information associated with the course structure can be obtained based at least in part on an input from an administrator or instructor. For example, an instructor can select a course structure. In some embodiments, the information associated with the course structure can be obtained based at least in part on a curriculum or information associated with an accreditation. For example, one or more requirements associated with a course structure corresponding to a curriculum or an accreditation can be used in connection with obtaining the course structure. In some embodiments, the information associated with the course structure corresponds to information corresponding to a structure of a course unit (e.g., a module, etc.). The course structure can include information indicating one or more types of assessments or learning activities to be used (e.g., presented to the user, to be completed by the user, etc.) in connection with the course, a number of assessments or learning activities to be used in connection with the course, an order of the assessments or learning activities to be used in connection with the course, etc. The LMS can obtain the information associated with the course structure. In some embodiments, the LMS can store (either locally or at a remote database) the information associated with the course structure in connection with the course. As an illustrative example, the instructor chooses a course unit structure and configures the types of activities the system will include in each unit, for example: 3 quizzes, 12 to 15 readings, 4 take-home assignments, 1 discussion forum.

At 220, one or more learning outcomes are obtained. One or more learning outcomes associated with the information associated with course structure can obtained. In some embodiments, the one or more learning outcomes can be obtained based at least in part on an input from an administrator or instructor. For example, an instructor can input (e.g., select) the one or more learning outcomes that the course (or unit or module thereof) is targeting. In some embodiments, the one or more learning outcomes can be obtained based at least in part on a curriculum or information associated with an accreditation. For example, one or more requirements associated with a course corresponding to a curriculum or an accreditation can be used in connection with obtaining the one or more learning outcomes. The one or more learning outcomes can be obtained by querying a database for learning outcomes associated with a course (or unit or module thereof).

At 230, one or more learning activities is determined. The one or more learning activities can be determined based at least in part on the one or more learning outcomes or the information associated with the course structure. In some embodiments, the learning activities can be determined based at least in part on an effectiveness value of the one or more learning activities associated with the one or more learning outcomes. The one or more learning outcomes can be obtained by querying a database for one or more learning activities associated with the one or more learning outcomes. The one or more learning activities can also be determined based at least in part on information associated with the course structure such as a type of learning activity or a number of learning activities.

In some embodiments, an effectiveness value of the one or more learning activities can be determined based at least in part on historical assessment information such as historical grades of students that completed the one or more learning activities. For example, an effectiveness value for a learning activity can be computed based at least on a chosen outcome in the course, N different activities that are aligned to the outcome can be found; N versions of the course including the N different activities aligned to the outcome can be found, and in each of the N courses, the system collects assessment data (grades obtained by students) on the outcome in each of the N courses. The grades can show a measure of effectiveness each of the N activities was in teaching the outcome. In some embodiments, the effectiveness value of a learning activity can correspond to a ranking of the N different activities. In some embodiments, the effectiveness value of a learning activity can correspond to a value associated with the assessment data (e.g., a normalized grade or the like) associated with the learning activity.

In some embodiments, the one or more learning activities are determined based on a selection of a predefined number of learning activities. For example, a predefined number of learning activities can be selected according to a ranking of the corresponding effectiveness values. The predefined number of learning activities can be selected from highest corresponding effectiveness value to lowest corresponding effectiveness value.

In some embodiments, the one or more learning activities are determined based on a determination of the learning activities having a corresponding effectiveness value exceeding a predefined threshold value. The threshold value can be configurable by an administrator or instructor.

In some embodiments, the one or more learning activities are determined based at least in part on an input from an administrator or instructor. For example, the effectiveness values of corresponding learning activities can be presented to the instructor and the instructor can select the one or more learning activities (e.g., based on the presentation of the effectiveness values of corresponding learning activities).

In some embodiments, the measure of effectiveness or effectiveness value of each of the N chosen learning activities can be updated to include the results from the batch of courses stored in, for example, a database associated with learning management system. The effectiveness value of the corresponding learning activities can be updated in real-time.

At 240, a learning module is configured. The learning module can be a course, a unit of a course, a module of the course, etc. In some embodiments, the learning module is configured based at least in part on the one or more learning activities. For example, the learning module can be configured to include the one more learning activities.

According to some embodiments, building and teaching N versions of the course may be done by relaxing the “each course is the same, except for the one activity”, to allow largely-similar courses as a basis for comparison.

Building a course takes place by building individual course units as follows: the instructor chooses a course unit structure and configures the types of activities the system will include in each unit, for example: 3 quizzes, 12 to 15 readings, 4 take-home assignments, 1 discussion forum; the instructor chooses a learning outcome that the course unit is targeting; choose those activities that have the highest rating when aligned to the outcome the unit is supposed to teach.

According to some embodiments, the system ensures that activities of all the types required in each course unit (configured above) are included in the unit.

2. Distribution of Learning Outcomes from Higher-Level Structure to Lower-Level Structure

Some embodiments include a distribution of learning outcomes from higher-level structures (e.g., programs, such as “Computer Science—Human Computer Interaction”) to lower-level structures (e.g., courses, such as “Single Variable Calculus”), as well with the reporting of results pertaining to learning outcomes back up, from lower-level structures to higher-level ones.

Information associated with one or more lower-level learning outcomes can be modified based at least in part on information associated with a higher-level learning outcome (e.g., a parent or other ancestor learning outcome to the one or more lower-level learning outcomes). Conversely, associated with one or more higher-level learning outcomes can be modified based at least in part on information associated with a lower-level learning outcome (e.g., a child or other heir learning outcome to the one or more higher level learning outcomes).

In some embodiments, distribution of learning outcomes further refines learning outcomes. For example, information associated with a learning outcome is pushed downward, from higher- to lower-level structures. In some embodiments, distribution of learning outcomes further informs learning outcomes as grades and results of students against learning outcomes are reported upward, from lower- to higher-level structures.

In some embodiments, a weighting can be applied to each learning outcome. For example, from the perspective of a high-level learning outcome, each lower-level learning outcome can have a corresponding weighting. The corresponding weighting can be used in connection with determining the aggregate higher-level learning outcome. For example, grades achieve in the lower-level learning outcomes can be correspondingly weighted in connection with determining a grade for the higher-level learning outcome. The weighting associated with the lower-level learning outcome can be defined based on a relative importance of the lower-level learning outcome. The importance can be assigned based on a curriculum, an accreditation, an input from an administrator or an instructor, etc. In some embodiments, the relative importance can be determined based on a semantic analysis of one or more resources associated with the lower-level learning outcome or the corresponding higher-level learning outcome.

As used herein, the terms “lower-level structures” and “higher-level structures” means conceptual layers people and organizations interested in education. Examples (from highest-level to lowest): university accreditation bodies, university programs, university courses.

### Distribution of Outcomes to Lower-Level Structures

Once learning outcomes have been defined in a higher-level structure, and arranged in trees, subtrees are copied into lower-level structures. The LMS can create a lower-level structure based on an input from an administrator or instructor, a curriculum, etc.

For example, the learning outcomes at the “Computer Science—Human Computer Interaction” program level may be:
“Ability to design a graphical UI” with child outcomes:
   “Understand accessibility”;
   “Functional design considerations”; and
   “Knowledge of color schemes”.
“Understanding of software performance” with child outcomes:
   “Big-O notation knowledge”; and
   “User perception of software performance”.

The learning outcomes can be distributed across a plurality of courses (e.g., in a program). The LMS can distribute the learning outcomes based on a predefined distribution, based on information associated with a curriculum or accreditation (e.g., a requirement thereof), or an input received from an administrator. For example, a program co-ordinator (staff member) may distribute learning outcomes to two of the courses in the program, as follows:

Course 1

“Ability to design a graphical UI” with child outcomes:
“Understand accessibility”; and
“Functional design considerations”.

“Understanding of software performance” with child outcomes:
“User perception of software performance”.

Course 2

“Understanding of software performance” with child outcomes:
“Big-O notation knowledge”.

Further, in each course, instructors may define activities and align to the learning outcomes provided in this fashion. These activities may be undertaken by students, who receive grades reflecting their performance on each outcome. For example, the LMS can provide the learning activities to a student in connection with administering a course (e.g., in connection with a student taking a class via e-learning).

Also, instructors themselves may refine the distributed learning outcomes that was pushed to the instructor. For example, the instructor can define a new lowest-level (or further lower-level) of outcomes. In some embodiments, the LMS can receive input from an instructor (e.g., from a client computing system associated with the instructor), such as:

“Ability to design a graphical UI” with child outcomes:
“Understand accessibility”;
   [ADDED BY INSTRUCTOR] “Considerations for persons with low vision”
   [ADDED BY INSTRUCTOR] “Considerations for persons with color vision impairments”

“Functional design considerations”

### Workflows Enabled by the Above Structure

### Lower-to-Higher Level Grades Reporting

The system may automatically report grades against higher-level learning outcomes by initially starting from lowest-level learning outcomes and the grades students achieved against the pertinent activities, according to some embodiments. Starting from these lowest-level learning outcomes, “outcome grades” may be computed going up the tree, based on the weights assigned to each of the lower-level learning outcomes. In some embodiments, the LMS or other computing system can determine grades of a higher-level learning outcome based on one or more lower-level learning outcomes corresponding to the higher-level learning outcomes. The grade of a higher-level learning outcome can be determined based on a weighting assigned to each of the one or more lower-level learning outcomes corresponding to the higher-level learning outcomes. The grades for a higher-level learning outcome and/or the lower-level learning outcomes can be stored in a database that stores a mapping of grades to learning outcomes. The grades for the lower-level learning outcomes can be obtained in connection with determining the grades for the higher-level learning outcomes. Therefore, a program co-ordinator can have access to grades against learning outcomes at the program level. Similarly, an accreditation body can have access to grades against learning outcomes at the university level.

### Coverage Checks Between Levels

In some embodiments, the system may automatically detect if the learning outcomes distributed to a lower-level structure do not cover the learning outcomes at the higher-level structure.

As an example, a learning outcomes in a university program whose child learning outcomes were missed (not distributed to a course) by the program coordinator can be identified. The system can compare the learning outcomes in a higher-level structure (e.g., learning outcomes corresponding to a university program) with the learning outcomes of the lower-level structures (e.g., of all the learning outcomes in the courses or other lower-level structure of the higher-level structure). The system can obtain a mapping of learning outcomes to higher-level structures from a database; and can obtain a mapping of learning outcomes to a lower-level structure from a database. The system can identify the learning outcomes that are not included in a lower-level structure based on the comparison of the learning outcomes in a higher-level structure (e.g., learning outcomes corresponding to a university program) with the learning outcomes of the lower-level structures (e.g., of all the learning outcomes in the courses or other lower-level structure of the higher-level structure).

As an example, learning outcomes in a course which have no activities aligned thereto can be identified. When a learning outcome is associated with a course but that course does not comprise any learning activities aligned with the learning outcome, reporting grades at the higher-level outcome is impossible (because no assessment is provided for the learning outcome). The system can compare the learning outcomes in a course with the learning outcomes associated each activity included in the course. The system can use the comparison of the learning outcomes in a course with the learning outcomes associated each activity included in the course to determine whether any learning outcome in a course does not have a corresponding activity included in the course.

As an example, an accreditation body can determine that not all learning outcomes a university must teach are being taught for a specific program. A report can be generated that identifies the learning outcomes taught in higher-level structures and lower-level structures. The system can compare one or more requirements associated with a curriculum or accreditation to learning outcomes in a program and/or lower-level structures associated with the program. Based on the comparison, the system can identify those learning outcomes included in the requirements associated with a curriculum or accreditation that are not included in a program and/or lower-level structures associated with the program.

### Automatic Synchronization Between Accreditation Bodies and Universities

In some embodiments, the system can obtain information associated with learning outcomes from one or more other systems. For example, the system can obtain information associated with learning outcomes from an accreditation body, a university, a department, etc. The system can determine (e.g., based on a comparison of sets of learning outcomes) whether a set of learning outcomes associated with any level structure (e.g., an accreditation, a degree, a course, etc.) or a program has changed. For example, the system can determine whether a new set of learning outcomes includes a learning outcome that was not included in the previous set of learning outcomes; if the new set of learning outcomes includes a learning outcome that was not included in the previous set of learning outcomes, such learning outcome can be deemed a new learning outcome. As another example, the system can determine whether a previous set of learning outcomes includes a learning outcome that was not included in the new set of learning outcomes; if the previous set of learning outcomes includes a learning outcome that was not included in the new set of learning outcomes, the learning outcomes can be deemed to be deleted. In the event that a new learning outcome or a deleted learning outcome is identified, the system can alert an administrator or instructor associated with administering or maintaining the program or other lower-level structure.

In some embodiments, the system comprises an interface to receive information associated with learning outcomes from one or more other systems.

In some embodiments, the system can obtain information corresponding to updates to the set of learning outcomes for a program (e.g., an accreditation, a degree, a course, etc.). For example, the updates can indicate the new learning outcomes (e.g., relative to the previous set of learning outcomes), and/or deleted learning outcomes (e.g., relative to the previous set of learning outcomes).

In some embodiments, when the accreditation body adds a learning outcome to its accreditation requirements, programs taught by an accredited university can be updated automatically to include the newly-added learning outcomes.

Further, if those newly-added learning outcomes have child outcomes in a outcomes bank (such as Achievement Standards Network (ASN) (located at http://www.achievementstandards.org/), those can be brought in automatically as well, populating the program outcomes.

The system can report on learning outcomes included in the program (e.g., an accreditation, a degree, a course, etc.) being provided by the system. The report can be used to determine what learning outcomes the system deems effective or valuable and that information can be used to refine requirements for a program. For example, accreditation bodies can learn whether if lack a certain outcome A, if the system detects that programs requiring accreditation consistently add outcome A (without it being required). This shows the accreditation body that perhaps outcome A ought to become mandatory for accreditation.

### Association of Rubrics to Outcomes

The system can store rubrics associated with learning outcomes. For example, rubrics can be attached to outcomes in any level structure (accreditation body, program, course, etc.), to guide the grading process a certain way.

An example of a rubric:

Level 1—Insufficient demonstration of ability

Level 2—Limited, occasionally-demonstrated ability

Level 3—Acceptable ability

Level 4—Proficiency; ability to teach others

In some embodiments, the lowest-level structure (usually a course) is the level at which the rubric levels can be chosen for each student, for each activity, effectively “grading against the rubric”.

### Association of Activities to Outcomes

The system can store associations between learning activities and learning outcomes. For example, similar to rubrics, activities can be attached to outcomes in any level structure (content publishers such as a publishing house, program, course, etc.), to guide the teaching process.

Examples of such activities:

Chapters of textbooks attached to outcomes by a content publisher

Exercises attached to outcomes by a publishing house

Survey attached to outcomes by the program coordinator

In some embodiments, performance (e.g., grades) associated with a learning activity or learning resource (e.g., a text), can be stored. The system can report on an effectiveness of an activity or a learning resource based at least in part on the performance. For example, the system can identify the learning activities or learning outcomes associated with a performance above a predefined threshold. The predefined threshold can correspond to a value of the performance or can be associated with a ranking of the learning activities and/or learning resources associated with the information relating to performance thereon. The information on performance or a report associated therewith can be provided to a content provider that published the learning activity and/or learning resources. For example, publishers can choose to stop providing a certain book, or author, if the relevant outcomes always show very low grades and results.

### Other Applications

In some embodiments, the distribution of outcomes across higher-level structures and lower-level structures can be implemented in the context of employment outsourcing, where the customer acts as the “accreditation body”, and the provider as the “university”.

In some embodiments, the distribution of outcomes across higher-level structures and lower-level structures can be implemented in the context activities (textbook chapters, exercises, etc.) provided with outcomes by publishing houses can be searched and ranked via how well students performed against those outcomes.

### 3. Simplification of Learning Outcome Hierarchies

Some embodiments include simplifying learning outcome hierarchies. For example, a method of simplification of learning outcome hierarchies is provided. The ultimate purpose is to make courses and education more efficient by removing learning outcomes which don't add enough value.

In some embodiments, an effectiveness of a learning outcome can be measured. The measure of the learning outcome can be used in connection with configuring a program, accreditation, course, etc.

As an example, if learning outcome A has learning outcomes B and C as children, then, when learning outcomes B and C have a massive knowledge overlap (e.g., the learning outcomes measure largely the same subject matter), the system will suggest that learning outcomes B and C could be merged or that one of learning outcome B and C could be removed. The system can determine an overlap between the learning outcomes based on an analysis of the activities associated therewith, an analysis of the one or more resources associated therewith (e.g., a semantic analysis of the one or more resources), etc.

The system may store all learning outcome hierarchies used in courses, and all assessments made against them, for all enrolled students.

According to some embodiments, Analysis of Variance methods (ANOVA) can be used in connection with determining whether, for a given student (or a given class), two outcomes (B and C from above) result in similar grades within the same activity (quiz, assignment, etc.) according to a preset frequency threshold. For example, if two outcomes frequently result in similar grades within the same activity, then the system may deem the two outcomes as substantially overlapping and thus being candidates for a merge of the two outcomes, or the removal of one of the two outcomes. In some embodiments, a Analysis of Variance method (ANOVA) is used used in connection with determining whether, for a given student (or a given class), two outcomes (B and C from above) result in similar grades within the similar activities (e.g., having a similarity value exceeding a predefined similarity threshold) according to a preset frequency threshold.

The reasoning behind ANOVA tools is to identify whether outcomes B and C effectively teach the same material with the same effectiveness by looking at the grades received on such outcomes under many circumstances (many students, many activities). (See https://en.wikipedia.org/wiki/Analysis_of_variance).

### 4. Generating Rubrics

In some embodiments, rubrics can be automatically generated for a user in a learning management system. An application of learning outcomes whereby rubrics (by which an outcome is graded/measured) are automatically generated for the instructor, as well as automatically graded for the students. The learning management system can use sensors to get automatic readings of the students' performance.

Examples include:
Accelerometer taking measurements of average acceleration throughout a driving road test (student must not accelerate quickly, or brake abruptly);
GPS (to see if proper route was followed) and speedometer during a road test;
Accelerometers used for physical education courses;
Counts of sentences ending with prepositions (grammar course); and
Chemical probes used during Chemistry lab experiments to measure mass of reactants, temperatures achieved, solution concentrations, etc.)

An LMS may be configured with one or more sensors, or may receive input data from one or more sensors.

Each assessment (driving test, lab experiment, etc.) can be aligned to multiple outcomes. For example, a driving road test could be aligned to outcomes “Ability to control vehicle speed” and “Ability to follow verbal directions”.

As used herein, the term “Rubric” is something that is used to grade an outcome, which may be based on levels such as:

| Level | Sensor Range |
|---|---|
| 1 | ±30% of ideal |
| 2 | ±20% to 30% of ideal |
| 3 | ±5% to 20% of ideal |
| 4 | ±0% to 5% of ideal |

As used here, “ideal” or “ideal value” means a per-outcome value that is automatically recorded or provided by the instructor. “Rubric levels” are relative to the ideal value.

### Setting Up Sensor Ranges and Ideal Value

In some embodiments, the LMS receives sensor ranges. For example, the instructor can input the sensor ranges for a rubric. The instructor prepares Sensor Ranges for each rubric through a variety of methods, such as: automatically-generated equal size ranges for each level (instructor specifies number of levels, and spread); example: 5 levels and spread of 50% would yield 5 rubric levels with sensor ranges of every ±10% of ideal value; and manually entered (e.g. as defined above).

The LMS can obtain an ideal value. For example, the instructor can input the ideal value. The instructor may populate the Ideal Value for each outcome being assessed. Examples for populating the ideal value include automatically generated from the instructor's own performance (instructor takes driving test himself and records acceleration, speed, etc.; or instructor performs chemical lab experiment himself, recording solution concentrations, temperature, etc.); and manually entered (acceptable number of sentences that can end in prepositions, etc.)

The learning outcomes are now prepared for the students to be assessed against. The LMS can store the learning outcomes.

### Workflow: Automatic Sensor-Based Assessments

As students undertake the assessment (taking a road test, lab experiment, etc.), the sensors (e.g., same type of sensors) which recorded the instructor's Ideal Value record the students' performance. The system can store the student's performance.

Based on the values recorded from a given student, the system may then find the Sensor Range within which the student's values fall, and award that Rubric level to the student, thus automatically assessing each learning outcome to which the assessment is aligned. The system can store the rubric level as a grade for the student in connection with the learning outcome.

### 5. Recommendation of Extra Qualifications

In some embodiments, a system may suggest extra qualifications that a user may attempt, on top of (e.g., in addition to) the user's planned learning path (e.g., one or more learning activities, courses, etc.). An example in the academic world would be a minor degree. An example in the professional world would be a certification, or a side-promotion, such as a software developer also gaining a “Team Lead” title, because she exhibited sufficient leadership skills.

As used here, “Incidental Outcome” means an outcome that is not part of a student's planned learning path, but to which an activity that the student completed is aligned.

### Example

Activity A1 is aligned to outcomes O1 and O2. In the event that the student's learning path only includes O1, O2 can be deemed to be an incidental outcome in relation to the student's learning path. For example, after having completed A1, the student has also satisfied O2 incidental.

In some embodiments, the system stores a mapping of outcomes needed for each degree, professional designation, role (software developer, manager, product manager, etc.).

### Workflow: Extra Qualification

Upon request, for each user, the system may perform a tree comparison (e.g., because learning outcomes are hierarchical) between the outcomes required by each available degree, professional designation, role in the system and the incidental outcomes achieved by the user.

When such comparison yields two similar enough learning outcome hierarchies (e.g., within a predefined threshold), the system informs the user that the user is close enough to obtaining the respective designation, promotion, etc.

### Example

outcomes O1, O2, O3 are needed to achieve a “Team Lead” title. A Software Developer already has achieved outcomes O1 and O2 from software development-oriented activities. The system will inform the user that she is close to achieving the “Team Lead” title, and listing the outcomes still needed (only O3 in this case).

### Workflow: Suggested Courses

In some embodiments, the system may deem that some outcomes become “easy” to achieve, after other outcomes have been achieved.

The system can also bias towards sequences of successful outcomes. For example, if many (above a threshold) students were successful in completing outcome A after outcome B, for example, then the system will bias towards suggesting a minor degree, professional designation, etc., when the student has achieved outcome A, and outcome B is part of said minor degree, professional designation, etc. The system can store information associated with students including outcomes completed and an order by which the outcomes are completed. In addition, the system can store performance values (e.g., grades) for the students in connection with the various outcomes completed by the students.

### 6. Design of Study Plan for Near Future Work Item

In some embodiments, a study plan can be designed using learning outcomes. For example, some embodiments allow a professional person to prepare for a near-future work item via LMS-suggested activities. Examples include a surgeon who is scheduled for a highly-specialized surgery in three days, or an auto mechanic who must work on an exotic car in two days.

As used herein, the term “Work item” means a job that the person has either completed in the past, or that is coming up within a few days. Work items are aligned to learning outcomes, just like any other activity.

As used herein, the term “Personal calendar” means the personal calendar of the professional person; which may include upcoming work items and training completed in the past. The system can store a personal calendar associated with a user. The user can access its personal calendar in connection with accessing the LMS.

As used herein, “Training materials” is akin to regular LMS course content, quizzes, etc., training materials are aligned to learning outcomes

Work items can be determined based on one or more characteristics associated with the user and/or an input from a user. For example, work items can be determined based at least in part on one or more activities on the personal calendar associated with the user within a predefined period of time (e.g., within the next week, next 48 hours, etc.). As another example, work items can be based at least in part on outcomes associated with the one or more activities on the personal calendar associated with the user. The system can obtain the personal calendar associated with the user, obtain the activities from the personal calendar, obtain the learning outcomes, and determine one or more work items to present to the user.

### Workflow

In some embodiments, the system monitors the personal calendar associated with one or more users. For example, the system looks ahead a few days. In the event that the system determines that the personal calendar includes an upcoming work item or activity, the system can determine learning outcomes relevant to which the work item is aligned. In some embodiments, the system calculates an extent to which the learning outcomes are “covered” (in essence, “how well is the person prepared for the upcoming work item?”). The system can calculate the extent to which the learning outcomes are covered based at least in part on recent past work items completed by the person; recent training materials completed by the person, recent feedback the person has received in connection with performance or outcomes for further focus.

If the “coverage” is lower than a configured threshold, the system obtains training materials that are aligned to the learning outcomes whose coverage was insufficient. In some embodiments, the system may schedule the best training materials available (by learning outcome relevance/overlap or a measured extent thereof) for the next few days before the work item occurs, adding the training materials to the person's calendar (the person's calendar can be associated with, or integrated in, the Learning Management System).

7. Personalized Grading Scheme Based on Learning Outcomes Associated with Learning Activities

A new approach to traditional grading can be designed using Learning Outcomes. A traditionally-graded student receives a grade for each activity they undertake. The student's activity grades are later averaged, and the teacher provides personalized feedback to accompany the single grade average number.

In some embodiments, the student focuses on the learning outcomes included each course. Thus, throughout the course, the student undertakes activities, each aligned to one or more outcomes. The grades received support outcomes.

The advantage is that the student, instructor, and parents better understand what the student is capable of, compared to the uninformative single-number grade average.

An analogy here is a medical patient exhibiting all normal physical exam measurements, except for critically-high blood pressure. A simple numeric average would not yield a cause for concern, whereas a “by-measurement” analysis makes it evident that the patient is in danger.

The following tables show a traditional grading for a given student and an outcomes-based grading for a given student.

### Traditional Grading for a Given Student

| Course Item | Grade Achieved |
|---|---|
| Assignment 1 | 30% |
| Assignment 2 | 80% |
| Test 1 | 73% |
| Midterm Average | 61% (hides student's lack of grasp of |
| | what Assignment 1 meant to teach) |

### Outcomes Grading for a Given Student

| | Outcome Grade Achieved |
|---|---|
| Course Outcome | (rubric level and numeric) |
| Outcome 1 | 40% (based on weighted |
| | average of assessments) |
| Outcome 1 portion of Assignment 1 | Rubric level 3, 70% |
| Outcome 1 portion of Assignment 2 | Rubric level 1, 10% |
| Outcome 2 | 70% (based on weighted |
| | average of assessments) |
| Outcome 2 portion of Assignment 1 | Rubric level 4, 80% |
| Outcome 2 portion of Test 1 | Rubric level 2, 50% |

The above assumes that Outcome 1 is aligned to activities Assignment 1 and Assignment 2, and that Outcome 2 is aligned to activities Assignment 1 and Test 1.

### Assignment 1 Rubric for Outcome 1

| Level | Numeric | Level Description |
|---|---|---|
| 1 | 0% | No demonstration of ability |
| 2 | 40% | Insufficient ability, only occasionally exhibited |
| 3 | 70% | Acceptable ability, demonstrated through at least |
| | | 3 practical lab group projects |
| 4 | 100% | Proficiency, demonstrated through also guiding |
| | | other students and groups |

### Assignment 2 Rubric for Outcome 1

| Level | Numeric | Level Description |
|---|---|---|
| 1 | 10% | Insufficient vocabulary to carry out a conversation |
| 2 | 60% | Can carry out a conversation, but makes verb tense |
| | | mistakes |
| 3 | 100% | Carries out conversations fluently, with good verb |
| | | tense and noun gender choices |

### Outcome-Based Report Card

Upon request, the system may generate a report card for a given student. The report card can include information indicating the student's performance in relation to one or more outcomes. For example, for each outcome, the system can include the outcome grade (e.g., which can be computed using a weighted average of the contribution of each assessment of an activity aligned to the given outcome).

In some embodiments, in connection with calculating the outcome grade, the system can be configured to bias the more recent assessments. The more recent assessments can be deemed to be more indicative of the student's present performance and capabilities. The biasing of the more recent assessments can be according to one or more predefined weightings. For example, weightings can be based on an amount of time between the date that the outcome grade is generated and the date on which the assessment was submitted to the system.

The report card can further include the outcome's textual description.

The report card can further include, for each rubric assessing the outcome, one or more of the rubric level (e.g., 1 through N), the rubric level's numeric grade, the rubric level's textual description, free-form feedback by the instructor for the student, on this rubric, and/or free-form feedback by the instructor for the student, on this outcome.

In some embodiments, the report card includes a student performance warning, meant for the student, instructor, and parents, in the event that student's outcome grade has dropped since the last report, the student is on a downward trajectory in the last few assessments against the outcome, indicating the student is getting worse at an increasing rate, etc.

### 8. Transfer of Learner Across Programs

In some embodiments, a student (e.g., a learner) can transfer between programs (e.g., learning programs). For example, a university student can transfer from a source program to a destination program. Learning Outcomes can be used in connection with the transfer of the student. The system can obtain the learning outcomes completed by the student and can obtain the learning outcomes associated with the destination program. Based on the learning outcomes completed by the student and the learning outcomes associated with the destination program, the system can determine the point (which semester, or which courses) in the destination program at which the student should start, what to do about outcomes the student has not yet met, given the starting semester, and what to do about outcomes already met, given the starting semester. The system can determine which courses in the destination program that the student does not need to complete based on the learning outcomes completed by the student and the learning outcomes associated with the destination program.

The system can determine outcomes to be equivalent (as a percentage) based at least in part on whether the outcomes have matching outcome identifiers, cross-walking rules defined by another user (accreditation body, admissions office, registrar, etc.), and each rule can define a degree of similarity between source and destination outcome node (that is, outcome A can be 75% “like” outcome B). The system can determine whether the degree of similarity exceeds a predefined threshold in connection with determining whether the outcomes are equivalent.

As used here, the term “Equivalence score” describes how much of a semester's outcomes have been already met by a given student.

The student may have a higher equivalence score for earlier semesters (compared to later semesters) in the destination program because programs specialize over time, and a student coming in from a different program is more likely to have achieved a larger proportion of outcomes in the earlier semesters, rather than in the later semesters.

The system obtains (e.g., identifies) the semester (or course or unit, or other level of structure) of study the student should be enrolled in the destination program. The system can obtain the semester of study in which the student should be enrolled based on a defined equivalent score threshold. In some embodiments, the earliest semester whose equivalence score is under the threshold is chosen.

The system can determine the missing experiences defined by outcomes that the student has not yet met. For example, although the student was placed in the identified semester, there are gaps in the student's demonstrated understanding. The system can recommend additional courses to cover the identified gap. The system can determine proposed substitutions for courses in the program as they may be a better fit for the student. The system can determine extra assessments to demonstrate that the student does in fact have this knowledge.

The system can determine (e.g., identify) which courses (or outcomes) the student should be exempt from based on the student's achieved outcomes from the student's source program. The system can propose exempting the student from the identified courses to an administrator. Based on the administrator's input (e.g., for authorization to exempt the student from the identified course), the system can update the required courses or an indication of which courses the student has completed or been exempted in relation to the student's learning path.

The system can substitute higher level courses for those courses whose outcomes the student has achieved already. For example, if the student already knows a particular topic, the student is presented with courses that explore the outcomes more in depth.

The system can substitute catch up courses for those courses whose outcomes the student has achieved already. For example, such substitution can avoid the waste time on requiring the student to spend time on outcomes the student has already demonstrated a proficiency, an instead present the student with courses to spend that time on closing the gap

### 9. Creating Groups Based at Least in Part on Learning Outcomes

Create groups such as study groups within a network such as creating groups within a Learning Management System.

1. Data Model of the System

Criteria

The information for each student for each criteria is collected automatically, manually (entered by instructor based on observations), or a mixture of both. The system can store this information in a database.

There are a few broad criteria categories, each with many criteria, as shown below:

Behavior in LMS:
Personality (entered by the instructor) (sociable, demur, positive/negative attitude
Activity on LMS-supplied forums (frequent poster, often online but never posts, etc.)
Meets deadlines (based on LMS-tracked data on students' ability to meet deadlines for taking quizzes, submitting assignments on time
Whether a certain student misses work entirely (homework, quizzes, required forum posts, etc.)
In-classroom lecture attendance
General online availability (whether a student is very often logged in to the LMS)

Learning Style
Visual vs. Auditory vs.
Independent learner vs. groups-based

Academic Profile
(Information can be grabbed from the LMS and/or integration with 3rd party Data store (SIS, etc.)
Program of Study
Academic Standing (GPA, conduct at the institution)
Year of Study
Past Courses
Enrollment in a co-op or internship program
Grades earned in current course (being taught by instructor)

Extra-Curricular Activity
Official clubs can have information made available in some manner to the LMS (REST API, etc.)
Information about this can also be entered by the instructor manually, for each student

Personal Background
Gender
Ethnicity
Special needs (wheelchair, etc.)

Set of Learning Outcomes the Student is Targeting (for their Degree, Etc.)
Includes student's assessment history on these targeted outcomes
Due to the hierarchical nature of outcomes, the system can infer that the student will do poorly in outcomes which are siblings of outcomes in which they scored poorly

Prior Group Membership
Information stored in the LMS
Could use Peer Reviews from that group to gather additional data about their contribution habits
Information about this can also be entered by the instructor manually, for each student

Student Information and its Representation

Student information is kept for each student enrolled in the LMS. Student information serves the purpose of evaluating each student according to the criteria defined above. An example student information record could be:

Mebastian Sihai
Gender: Male
Grade in current course: 78%
In-class attendance: Good
Program of Study: Computer Science
Enrollment in co-op/internship program: Yes
Ethnicity: Caucasian
Extra-curricular activity: Member of 0-3 University clubs
Meets deadlines: Good
Personality: Sociable
Year of study: 3
GPA: 3.01
General online availability: Medium

The steps presented below would be followed in this order by a user who wishes to create study groups.

Student Pool Selection

The system can identify the student pool. The Student Pool is the set of all students who are available for distribution to groups. An example of a student pool could be a course offering, such as Calculus I, summer 2014. Here is an example student pool, where each student information record holds [Gender, Grade in current course, In-class attendance]:
[Male, 72%, Good]
[Female, 90%, Excellent]
[Female, 70%, Poor]
[Male, 41%, Poor]
[Male, 19%, Good]
[Female, 39%, Poor]
[Female, 64%, Good]

Criteria Selection

Prior to generating student groups, the instructor can select criteria, from the many criteria defined in the “Criteria” section above, and via a user interface:

Assume the instructor selects:
Gender
Grade in current course
In-class attendance

In some embodiments, order is important, as will be evident from below. Essentially, the order determines which criteria are more important than others.

Automatic Learning Outcomes Bucket Selection

When Learning Outcomes is chosen as a criterion above, the system may determine top K target outcomes. A target outcome is one where enough students exhibited poor performance, which makes it a good target for group study.

The system allocates one bucket for each target outcome.

The workflow continues with manual bucket selection.

Manual Bucket Selection

For each criterion selected above, the instructor may configure buckets, via the user interface. Buckets are specific to each criterion. Some buckets may be configurable (such as the Grade in current course bucket below, where the instructor can select to have maybe 10 buckets, each for a decile, rather than the two buckets chosen below as an example).

Assume the instructor selects:
Gender—buckets are Male and Female
Grade in current course—buckets are 0%-50%, 51%-100%
In-class attendance—buckets are Poor, Good, Excellent

Number of Groups Selection

The instructor selects how many groups are to be created. Let us assume that the user has chosen 3 groups.

Distribution Type Selection

The distribution type determines how the students are ultimately assigned to groups. An example of a distribution type is: similar—this distribution type assigns “similar” students in the same group. Another example of a distribution type of mixed—this distribution type tries to form groups which are as balanced as possible.

The user may now initiate the group creation. Assuming we are working with the data presented above, here's what would happen:

(Students are presented here again, for readability)
[Male, 72%, Good]
[Female, 90%, Excellent]
[Female, 70%, Poor]
[Male, 41%, Poor]
[Male, 19%, Good]
[Female, 39%, Poor]
[Female, 64%, Good]

Going through criteria one by one, students are arranged in continually-refined buckets as such:
Gender phase—arrange students in the buckets defined for the Gender criterion, which are Male and Female:

| Male bucket | Female bucket |
|---|---|
| [Male, 72%, Good] | [Female, 90%, Excellent] |
| [Male, 41%, Poor] | [Female, 70%, Poor] |
| [Male, 19%, Good] | [Female, 39%, Poor] |
| | [Female, 64%, Good] |

Grade in current course phase—assign this criterion's buckets to each of the existing buckets, then arrange students in each:

| Male bucket | | Female bucket | |
|---|---|---|---|
| 0%-50% bucket | 51%-100% bucket | 0%-50% bucket | 51%-100% bucket |
| [Male, 41%, | [Male, 72%, Good] | [Female, 39%, | [Female, 90%, |
| Poor] | | Poor] | Excellent] |
| [Male, 19%, | | | [Female, 70%, |
| Good] | | | Poor] |
| | | | [Female, 64%, |
| | | | Good] |

In-class attendance phase—repeat operation

| Male bucket | | Female bucket | |
|---|---|---|---|
| | 51%-100% | | 51%-100% |
| 0%-50% bucket | bucket | 0%-50% bucket | bucket |
| Poor bucket | Poor bucket | Poor bucket | Poor bucket |
| [Male, 41%, | | [Female, 39%, | [Female, 70%, |
| Poor] | | Poor] | Poor] |
| Good bucket | Good bucket | Good bucket | Good bucket |
| [Male, 19%, | [Male, 72%, | | [Female, 64%, |
| Good] | Good] | | Good] |
| Excellent bucket | Excellent bucket | Excellent bucket | Excellent bucket |
| | | | [Female, 90%, |
| | | | Excellent] |

Therefore, given the selected criteria of:
Gender—buckets are Male and Female
Grade in current course—buckets are 0%-50%, 51%-100%
In-class attendance—buckets are Poor, Good, Excellent

This is the arrangement of students after this sorting has been performed:
[Male, 41%, Poor]
[Male, 19%, Good]
[Male, 72%, Good]
[Female, 39%, Poor]
[Female, 70%, Poor]
[Female, 64%, Good]
[Female, 90%, Excellent]

The identified students can be organized in groups. The distribution types identified above will be used as illustrative examples.

### “Similar” Distribution Type

The student pool contains 7 students that need to be distributed in 3 groups. Via simple division, the system calculates group sizes of 3, 2, 2 for the three groups, respectively.

One by one, from top to bottom, the students from our arrangement are placed in each group until it fills as shown below:

(Fill in First Group)

| Group 1 | Group 2 | Group 3 |
|---|---|---|
| [Male, 41%, Poor] | | |
| [Male, 19%, Good] | | |
| [Male, 72%, Good] | | |

(Fill in the Second Group)

| Group 1 | Group 2 | Group 3 |
|---|---|---|
| [Male, 41%, Poor] | [Female, 39%, Poor] | |
| [Male, 19%, Good] | [Female, 70%, Poor] | |
| [Male, 72%, Good] | | |

(Fill in the Third Group)

| Group 1 | Group 2 | Group 3 |
|---|---|---|
| [Male, 41%, Poor] | [Female, 39%, Poor] | [Female, 64%, Good] |
| [Male, 19%, Good] | [Female, 70%, Poor] | [Female, 90%, Excellent] |
| [Male, 72%, Good] | | |

The groups are now formed. The system can save the groups. In some embodiments, the system can output the groups to an administrator or instructor. In some embodiments, the system groups the students according to the formed groups for a particular course, assessment, activity, etc.

Mixed” Distribution Type

The student pool contains 7 students, which need to be distributed in 3 groups. One by one, from top to bottom, the students from our arrangement are placed one-by-one in each group progressively as shown below:

(First Pass)

| Group 1 | Group 2 | Group 3 |
|---|---|---|
| [Male, 41%, Poor] | [Male, 19%, Good] | [Male, 72%, Good] |

(Second Pass)

| Group 1 | Group 2 | Group 3 |
|---|---|---|
| [Male, 41%, Poor] | [Male, 19%, Good] | [Male, 72%, Good] |
| [Female, 39%, Poor] | [Female, 70%, Poor] | [Female, 64%, Good] |

(Third Pass)

| Group 1 | Group 2 | Group 3 |
|---|---|---|
| [Male, 41%, Poor] | [Male, 19%, Good] | [Male, 72%, Good] |
| [Female, 39%, Poor] | [Female, 70%, Poor] | [Female, 64%, Good] |
| [Female, 90%, Excellent] | | |

The groups are now formed. The system can save the groups. In some embodiments, the system can output the groups to an administrator or instructor. In some embodiments, the system groups the students according to the formed groups for a particular course, assessment, activity, etc.

In some embodiments, the user can create conditions. A condition can be of the form “each group must contain at least one female”, or “no group can contain more 50% failing students”. The user can input the condition to the system.

In the case that one of these conditions is defined, during the group population steps described in the previous sections, the following applies:
Before assigning a student to a group, check if:
   In the case of a “must contain . . . ” condition, ensure the conditions are satisfied first
   In the case of a “cannot contain . . . ” condition, ensure that the condition is not broken for each student

Now, as before, we proceed student-by-student. A determination is made as to whether to skip the current student either because: not all groups contain a female yet, or: adding this student would cause the group to have more than 50% failing students then, the current student can be placed on a temporary list, and proceed with the next student in the arrangement, re-checking the temporary list every time we move forward to the next student.

Gauge Effectiveness of Activities

Given a learning outcome, the system creates groups based on activities A1, A2, A3, which are all aligned to the learning outcome. Aside from being assigned different activities, the groups are similar.

The effectiveness of activities A1, A2, A3 is calculated by the change in student performance before and after participation in the group.

Manual Adjustments

After the group assignment has been performed, the system provides an interface by which the instructor is given a chance to adjust the groups manually, via a user interface.

### 10. Alignment of Text to Video

Align fragments and words of English text to time intervals inside a recorded video lecture, within the context of a course in an LMS. According to some embodiments, this allows for automatic referencing of specific lecture video intervals from plain, written text.

### System Components

1. Database of recorded lectures (video)

2. A system to transcribe (natural language recognition) (speech to text)

3. Learning Outcomes distributed among courses and programs

4. Course content:
a. Books from publishers (containing chapters, topics, etc.)
b. Readings supplied by instructor
c. Activities (quizzes, quiz questions, discussion forums, assignments)

The system takes all recorded lectures from the current course and transcribes them into plain English text. The system compiles a list of interesting words and sentence fragments, either input by the instructor, or by doing a frequency analysis of words specific to the field of the course (Mathematics, Physics, etc.). Using semantic analysis and natural language processing, occurrences of interesting words and sentence fragments are looked up, and recorded, in: all course content in this course, all learning outcomes in this course, and all transcripts of lecture videos in this course.

The above creates four sets of references [Interesting word or sentence fragment] to [course content item]; [Interesting word or sentence fragment] to [activity] to [learning outcome] (since activities are aligned to learning outcomes); [Interesting word or sentence fragment] to [learning outcome text]; and [Interesting word or sentence fragment] to [lecture video interval]

The system can also create the references [learning outcome] to [lecture video interval], and [course content item] to [lecture video interval].

### A Sample Automatic Referencing

Given the following LMS forum thread:
Joe: “Laplace Transforms are difficult; I hate them, and wish I were a Liberal Arts student!”
Jack: “I think you'd appreciate them more if you knew they are used for analyses in many disciplines.”

Assume the words and fragments “Laplace Transforms”, “disciplines” were marked as interesting from before. The system would search through the lecture transcripts, arriving at the fragment
“ . . . In physics and engineering it is used for analysis of linear time-invariant systems such as . . . ”
   which is mentioned in the lecture between 12:30 and 13:51. The system has mapped “Laplace Transforms” to the interval [12:30, 13:51].

Learning outcomes which have a similarity to “Laplace Transforms” are now also mapped to the lecture video interval [12:30, 13:51], allowing students to look up lecture video fragments by learning outcomes.

Also, whenever “Laplace Transforms” are now mentioned in forum discussions, student chats, readings, etc., a reference is added to the lecture video interval [12:30, 13:51].

### Operations of the System

According to some embodiments, the method, device, and system may operate to provide: cross-lecture video referencing: as a video is playing, annotations can appear on screen, sending the user to other lecture videos which discuss similar topics; automatic annotations on readings, discussions, forums, chats referencing lecture video fragments; automatic annotations on study material: when the system detects that a user has spent a long time on one question or problem, it will start showing links to lecture video time intervals that may assist the student; and automatic suggestion of recap material based on badly or unanswered questions on practice quizzes and exams.

Students can focus their attention on specific lecture time intervals for each of the learning outcomes they must satisfy.

Because learning outcomes are hierarchical, high-level outcomes can be audited by a program coordinator; the program coordinator can tell if a certain outcome is to taught properly by an instructor, by reviewing the lecture time intervals which relate to low-level outcomes rolling up to the high-level one.

Suitability of reading materials: after parsing all lecture videos, the system can inform the instructor whether there are nodes (chapters, sections, etc.) in the reading material tree which do not reference any lecture video time intervals. This means that the lectures did not cover those chapters, sections, etc.

Similar operations as above may be performed, but for outcomes

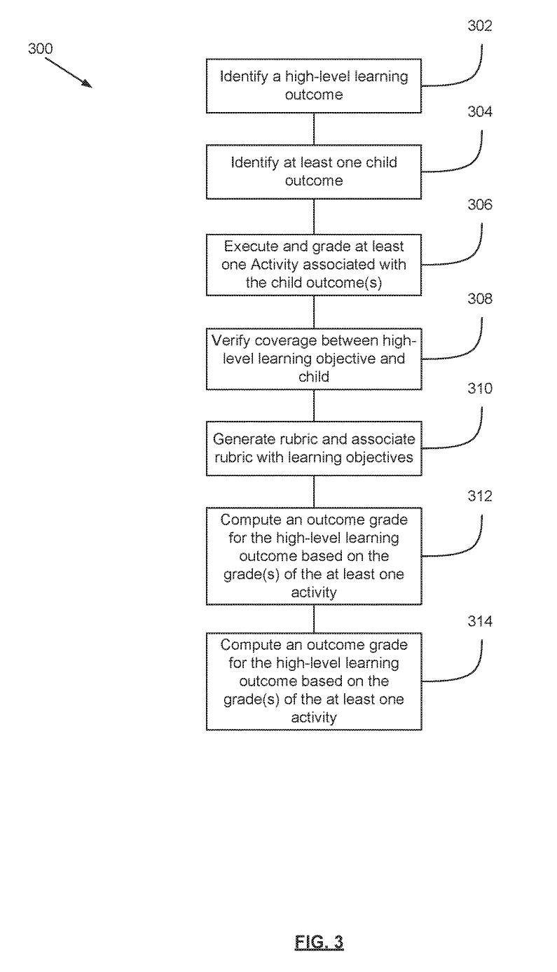

Referring to FIG. 3, there is shown a method 300 for managing and using learning outcomes. The method begins at 302, when an instructor or teacher (or other educator or administrator) identifies a particular high-level outcome, according to the hierarchy previously described. At step 304, the instructor or teach identifies at least one child outcome (i.e. low-level learning outcome) associated with the high-level outcome.

At step 306, at least one activity associated with the child outcome(s) is identified and executed. A grade is assigned to the activity based on the student's performance during the activity. At step 308, a coverage check between levels is performed, in order to detect if the learning outcomes distributed of the lower-level (child) structure cover the learning outcomes of the higher-level structure.

At step 310, a rubric may be generated, and/or associated with the learning objectives previously identified.

At step 312, an outcome grade can be calculated and associated with the high-level learning outcome based on the grades obtained from the activities performed in relation to the low-level (child) learning objectives.

At step 314, recommendations can be made for extra qualifications, based on the activities performed, and/or the grades obtained based on the activities.

While the above description provides examples of one or more apparatus, methods, or systems, it will be appreciated that other apparatus, methods, or systems may be within the scope of the claims as interpreted by one of skill in the art.

1. A method for managing and using learning outcomes, comprising:
a) identifying a high-level learning outcome;
b) identifying a first low-level learning outcome associated with the high-level learning outcome and a second low-level learning outcome associated with the high-level learning outcome;
c) obtaining a first grade for a first activity associated with the first low-level learning outcome and obtaining a second grade for a second activity associated with second first low-level learning outcome; and
d) calculating an outcome grade pertaining to the high-level learning outcome based on the first grade and the second grade.

2. A system for managing and using learning outcomes, comprising:
one or more processors configured to:
identify a high-level learning outcome;
identify a first low-level learning outcome associated with the high-level learning outcome and a second low-level learning outcome associated with the high-level learning outcome;
obtain a first grade for a first activity associated with the first low-level learning outcome and obtaining a second grade for a second activity associated with second first low-level learning outcome;
calculate an outcome grade pertaining to the high-level learning outcome based on the first grade and the second grade; and
one or more memories configured to provide the one or more processors with instructions.

3. A computer program product, the computer program product being embodied in a non-transitory computer readable storage medium and comprising computer instructions for:
identifying a high-level learning outcome;
identifying a first low-level learning outcome associated with the high-level learning outcome and a second low-level learning outcome associated with the high-level learning outcome;
obtaining a first grade for a first activity associated with the first low-level learning outcome and obtaining a second grade for a second activity associated with second first low-level learning outcome;
calculating an outcome grade pertaining to the high-level learning outcome based on the first grade and the second grade
